(19) United States
(12) Patent Application Publication
(10) Pub. No.: US 2007/0024442 A1
(43) Pub. Date: Feb. 1, 2007

(54) Door bolt position detection system with light switching capability and a backup timer

(76) Inventors: Daniel M. Jolley, West Jordan, UT (US); William R. Carlson, Mapleton, UT (US)

Correspondence Address: Anthony Carlis;Invent This Inc!, Suite 1D, 110 Hopewell Road, Downingtown, PA, 19335, US

(21) Appl. No.: 11/484,992

(22) Filed: Jul. 12, 2006

Related U.S. Application Data
(60) Provisional application No. 60/702,572, filed on Jul. 26, 2005.

(51) Int. Cl. E05B 45/06

(52) U.S. Cl. 340/542

(57) ABSTRACT

A door latch position detection system incorporating light switching capability and a backup timer includes a relay that is used to switch on the storage unit lighting powered by line voltage. The system includes an AC to DC converter that converts and filters the line voltage to low voltage DC power. The low voltage is fed to a reed switch within a switch housing attached to the overhead door track. When the reed switch that controls the storage unit lighting is closed by withdrawal of the bolt from the track aperture, a low voltage power signal is sent through a normally-on switch to the coil of the relay, thereby closing the relay contacts and turning on the storage unit lights. A timer shuts off the current to the relay after a set period. The present invention may also be utilized in a garage or closet to conserve energy.

### CROSS REFERENCE TO RELATED APPLICATIONS

This application is related to U.S. provisional application Ser. No. 09/659,862, now U.S. Pat. No. 6,359,538 dated Mar. 19, 2002, by the same inventors, which is incorporated by reference as if fully set forth.

### BACKGROUND OF THE INVENTION

This invention relates to door position detection systems employing magnetic reed switches. A reed switch is a mechanical electrical switch having a pair of ferromagnetic contacts in either a normally-open or normally-closed configuration. In the presence of a magnetic field, the contacts of a normally-open reed switch will close, conversely the contacts of a normally-closed read switch will open. Reed switches are typically used as proximity sensors for limit, safety, and security applications.

Overhead security doors are generally mounted between two parallel tracks. For buildings having a height at least double the door height, the tracks may be entirely vertical. However, for buildings having a height less than double the door height, vertical tracks are used for the closed door position, and horizontal tracks are used for the open position. The vertical and horizontal tracks are interconnected by curved sections. As a general rule, overhead doors are secured by a pair of bolts which can be horizontally extended or retracted by rotating a locking handle coupled to both bolts. When the door is fully closed and the bolts are in their extended positions, one bolt is inserted within an aperture in one of the tracks, and the other bolt is inserted within an aperture in the opposite track.

Reed switches are now routinely used to detect the position of the looking bolt on overhead doors. Devices are being produced which securely mount a reed switch and its associated magnet on an overhead door track. The reed switch and its magnet are on opposite sides of a bolt-receiving aperture of overhead door's track. As a ferromagnetic bolt is employed to look the door, the bolt interferes with the magnetic field, thus affecting the reed switch's contacts. The reed switch remains unaffected by the magnetic field as long as the ferromagnetic bolt is in its locked position. As the bolt is withdrawn from the bolt-receiving aperture, the magnetic field is then permitted to act upon the reed switch by opening or closing its contacts.

Overhead doors are commonly used to provide access to individual storage rooms, or units within a public or private storage facility. If storage access is obtained via an outside door, the individual storage room will often require illumination for nighttime access. In addition, the storage room may be located inside a storage facility structure, but may not have enough lighting near the entrance of the storage room to be usable by a tenant. In any case, having lighting available within the room is often desirable. However, the provision of interior lighting for individual storage rooms is problematic; the tenant may fail to turn off the lights when he or she leaves the storage facility. There have been many attempts to control the internal lighting with a switch connected to the bolt. However, this method of controlling the internal lighting suffers from the drawback that when the individual storage room is if left unlocked—either inadvertently or during periods when it is not rented the lights will remain on. Another problem with a bolt related switch is that the switch may fail in the on position with the lights remaining permanently on. For these reasons, owners of many storage facilities have been reluctant to provide interior lighting for individual storage rooms because it may significantly drive up their utility expenditures.

### SUMMARY

The present invention solves the heretofore noted problems relating to providing internal lighting for individual storage rooms, or units, within a public or private storage facility. The present invention provides both a security system bolt position sensor and lighting control system for overhead doors. For an embodiment of the present invention, the bolt position sensor and the lighting control system are controlled by separate reed switch contacts mounted within a common housing attached to one of the overhead door tracks adjacent the bolt aperture therein. The housing is shaped so that the reed switches are on one side of the bolt aperture and a permanent magnet is on the other aide of the bolt aperture. When the door is locked and the bolt is installed within the track aperture, the magnetic field of the permanent magnet is disrupted so that the reed switches assume their normal positions. The reed switch which controls the lighting control system is a normally open switch. When the bolt is withdrawn, the contacts close. The reed switch which provides a bolt detection signal may be either normally open or normally closed, depending on the logic used by the security system. If a normally open reed switch is used, a signal voltage is indicative of the bolt being withdrawn from the track aperture. Conversely, if a normally closed reed switch is used, a break in signal voltage is indicative of the bolt being withdrawn.

A relay is used to switch on the storage unit lighting, which is preferably either incandescent or fluorescent lighting powered by 110-120 line voltage. The lighting control system includes an AC to DC converter that preferably employs a full-wave bridge rectifier and a filter to convert the line voltage to low voltage DC power. This low voltage power is fed to the reed switches within the housing. In the event of a power failure, an alternate DC power source can be utilized. For example, a battery backup system with a voltage regulator or an emergency generator also connected to a voltage regulator.

When the reed switch that controls the storage unit lighting is closed by withdrawal of the bolt from the track aperture, a low voltage power signal is sent through a normally-on switch to the coil of the relay, thereby closing the relay contacts and turning on the storage unit lights. The normally-on switch is a p-channel insulated gate field effect transistor (IGFET). At the same time the low voltage is sent through the normally-on switch, it is also sent to a timing circuit which controls the normally-on switch. The IGFET acronym is a general term and is almost synonymous with “MOSFET” (metal-oxide-semiconductor field-effect transistor.) IGFET can also refer to FETs (field-effect transistors) with a non oxide gate insulator. Additionally, the term “IGFET” may also refer to devices with polysilicon gates, but most may still be referred to as MOSFETs.

A timing circuit includes a long, narrow n-channel IGFET that operates as a resistor. The gate of the long, narrow n-channel IGFET is hard-wired to the low voltage signal source through a variable resistor, which can be adjusted to increase or decrease the flow of current through the channel of the transistor. Current which passes through the channel is fed to the gate of the p-channel IGFET through a path which is grounded through a capacitor. The capacitance value of this capacitor determines the time required for the voltage on the gate of the p-channel IGFET to reach the threshold value for the transistor. When the threshold value is reached, current through the channel of the p-channel IGFET is cut, thereby deactivating the relay coil, opening the relay contacts and shutting off the storage unit lights. A reset switch provides a means to discharge the capacitor and reset the timing circuit, thereby resetting the voltage on p-channel IGFET to zero and switching on the lights. The capacitor will then recharge and eventually turn off the lights. The time between the closing of the reed switch contacts and the turning off of the storage unit lights may be lengthened by increasing the capacitance of the capacitor, decreasing the conductivity of the N-channel IGFET, and increasing the resistance of the variable resistor. The first two methods require a selection of components for incorporation into the circuit at the time of circuit manufacture. The latter method is adjustable in the field.

If the contacts of the reed switch are delicate and unable to handle the amount of current required to activate the relay, the low voltage signal from the reed switch may be used to control the gate of a second N-channel IGFET, which supplies sufficient current to activate the relay. It should also be mentioned that the p-channel IGFET is protected against voltage surges by a path to ground through a reverse-biased diode.

In addition, the present invention can be utilized by a homeowner to control the lighting inside a closet, a garage or any other storage area with a door latch capable of engaging and activating the reed switch.

### BRIEF DESCRIPTION OF THE DRAWINGS

FIG. 1 is a block diagram of the overhead door bolt position detection system incorporating light switching capability and a backup timer.

FIG. 2 is an embodiment circuit diagram of the overhead door bolt position detection system incorporating light switching capability and a backup timer.

FIG. 3 a second embodiment circuit diagram of the overhead door bolt position detection system incorporating light switching capability and a backup timer.

### DETAILED DESCRIPTION OF THE PREFERRED EMBODIMENTS

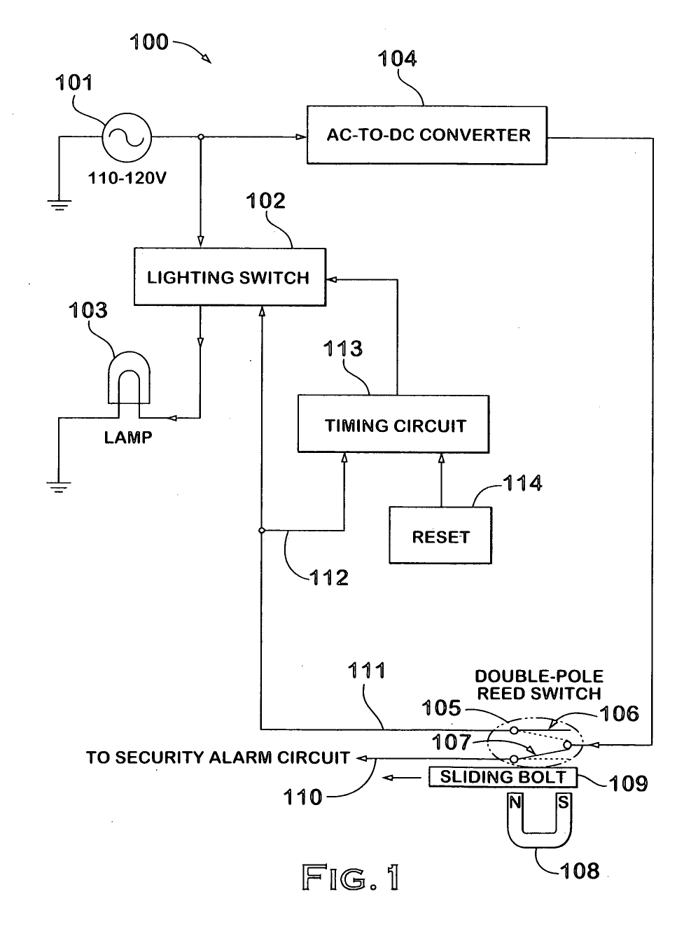

The invention will now be described with reference to the attached drawing figures. Referring to the block diagram of FIG. 1, a generalized circuit 100 for implementing the invention is shown. 100-120 volt alternating line current 101 is fed to both a lighting switch 102 and to an AC-to-DC converter 104. DC output from converter 104 is fed to a double-pole reed switch 105. For this particular embodiment of the invention, a portion of the reed switch 105 is utilized to control a lighting circuit is normally open and the same reed switch used for a security alarm signal generation, which is in the normally closed section. A sliding bolt 107 is fabricated from a ferromagnetic material, such as iron or steel. When placed between the permanent magnet 106 and the reed switch 105, the bolt 107 interferes with the propagation of the magnetic field of the magnet 108, and the reeds assume their normal positions. However, when the bolt 107 is withdrawn from between the magnet 106 and the reed switch 105, the reeds are attracted by the magnetic field so that they assume new positions, as indicated by the dashed lines of FIG. 1. Thus, when the sliding bolt 107 is withdrawn, reed switch 106 produces a signal state change on line 110 for the security alarm circuit, and reed 107 produces a closed circuit which sends an “ON” signal to the lighting switch 102 via path 111, thereby turning on the lamp 103, and a set signal to the timing circuit 113 via paths 111 and 112. After a preset time period has elapsed from receipt of the set signal the timing circuit 113 sends an “OFF” signal to the lighting switch 102, thereby turning off the lamp 103. A reset switch 114 resets the timing circuit so that the lamp 103 can be turned on again once the timing circuit 113 has timed out.

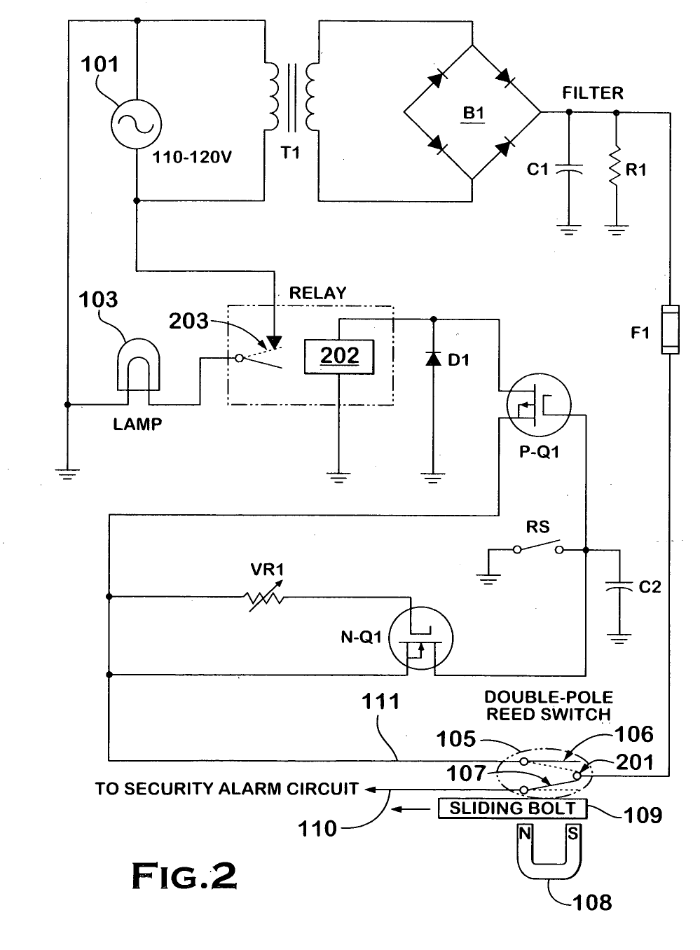

Referring now to FIG. 2, which is a circuit diagram of an embodiment. A step-down transformer T1 is coupled to the 100-120 volt alternating current line voltage 101. Output from transformer T1 is sent to a bridge rectifier B1. Output from bridge rectifier B1 is filtered by capacitor C1 and resistor R1 to provide low-ripple DC current, which is passed through a fuse F1 en route to the input terminal 201 of the double-pole reed switch 105. Although a single pole reed switch might be used in place of the double-pole variety, the double-pole reed switch 105 isolates the security circuit from the lighting control circuit. For this particular embodiment, the reed-used to control the lighting circuit which is normally open, while the reed used for security alarm signal generation is normally closed. A sliding bolt 107 is fabricated from a ferromagnetic material, such as iron or steel. When placed between the permanent magnet 106 and the reed switch 105, the bolt 107 interferes with the propagation of the magnetic field of the magnet 106, and the reeds assume their normal positions. However, when the bolt 107 is withdrawn from between the magnet 106 and the reed switch 105, the reeds are attracted by the magnetic field so that they assume new positions, which are indicated by the dashed lines. Therefore, when the sliding bolt 107 is withdrawn, reed 106 produces a signal state change on line 110 for the security alarm circuit, and reed 107 produces a positive voltage on line 111. Line 111 feeds a p-channel IGFET P-Q1, which acts as a normally-on switch when no voltage is applied to its gate. As soon as current reaches the channel of IGFET P-Q1, it is passed to the coil 202 of relay RL1. As the coil 202 is energized, the contacts 203 of relay RL1 close, and the lighting of the storage unit, represented by lamp 103, is turned “ON”. Line 111 also provides an input to the channel of n-channel IGFET N-Q1. IGFET N-Q1 has a long, narrow channel, which acts a current limiter. The output of that channel is applied to the gate of transistor P-Q1. Line 111 also provides an input to the gate of a first n-channel IGFET N-Q1 through variable resistor VR1. The flow of current through the channel of IGFET N-Q1 can be fixed by setting the resistance value of variable resistor VR1, which controls the voltage applied to the gate of IGFET N-Q1. A capacitor C2 is also coupled to the gate of IGFET P-Q1, and acts as a current sink. The capacitance value of capacitor C2 will determine the length of time between the activation of relay RL1 and the point in time when the voltage on the gate of IGFET P-Q1 reaches the threshold voltage value of IGFET P-Q1. When voltage on the gate of IGFET P-Q1 reaches the threshold value, IGFET P-Q I will start to turn off. Current flow through IGFET P-Q1 will soon be reduced to the point that the magnetic field of coil 202 is unable to maintain the contacts 203 closed, thereby cutting off power to lamp 103. A diode d1 protects IGFET P-Q1 from voltage surges which occur as the magnetic field of coil 202 collapses when power to it is cut. A reset switch RST, which is accessible to the user of the storage unit, allows the user to reset the voltage on the gate of IGFET P-Q1 to ground potential by discharging capacitor C2. When the voltage on the gate of IGFET P-Q1 is reset, the relay RL1 is reactivated, and lamp 103 is again turned on.

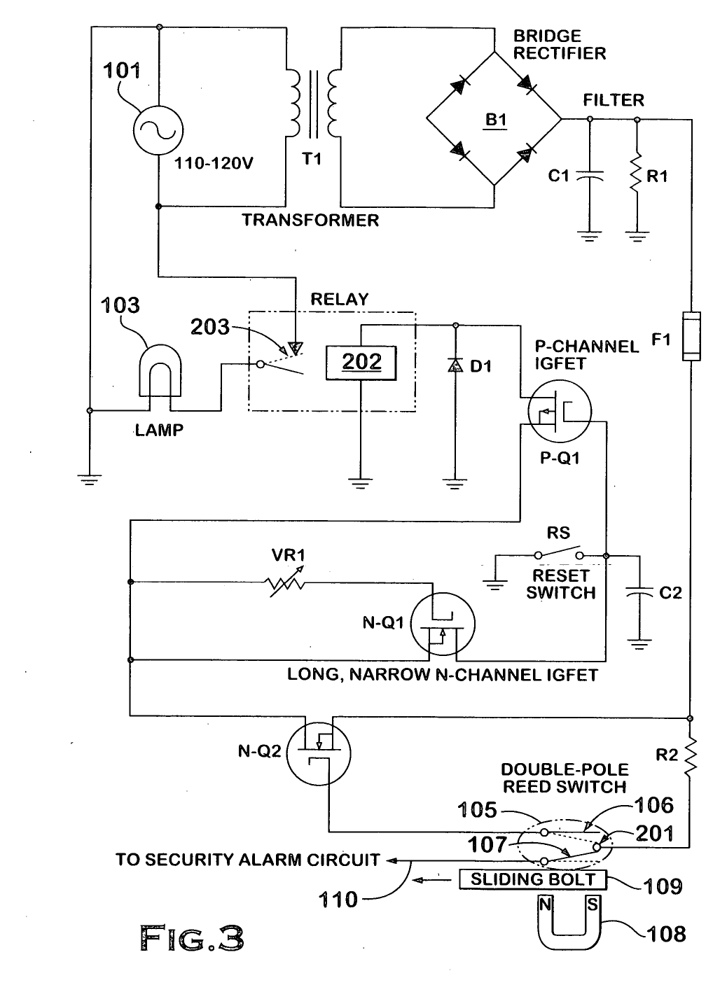

Referring now to FIG. 3, which is a circuit diagram of an embodiment. This circuit is a variant of the previous embodiment, as discusses above. The primary difference between the two circuits is that the output from the double-pole reed switch 105 is not fed directly to the coil 202 through IGFET P-Q1. This change in the circuit has been made to minimize the current flow through the contact 106 of the double-pole reed switch 105, which feeds the coil 202. Rather, it is fed to the gate of a second n-channel IGFET N-Q2, which acts as a switch to pass current to the coil 202 through IGFET P-Q1. Resistor R2 reduces the voltage of the DC output from the bridge rectifier B1, both to provide voltage compatibility with IGFET N-Q2 and to reduce arcing as the contacts of double-pole reed switch 105 open and close.

Although only two embodiments of the switch assembly are disclosed herein, it will be obvious to those having ordinary skill in the art that changes and modifications may be made thereto without departing from the scope and the spirit of the invention as hereinafter claimed.

What is claimed is:

1. An overhead door bolt position detection device with light switching capability and a backup timer, comprising
a step-down transformer coupled to a first alternating voltage and to a bridge rectifier;
a filter capacitor and a resistor to provide low-ripple DC current, which is passes through a fuse;
a double-pole reed switch to isolate a security circuit from a lighting control circuit;
a sliding bolt fabricated from a ferromagnetic material, such that when said sliding bolt is positioned between a permanent magnet and a reed switch, said sliding bolt interferes with the propagation of the magnetic field of said permanent magnet allowing at least one of a plurality of reeds in said reed switch assume a normal position changing a state level; and
a first insulated gate field effect transistor (IGFET) connected to at least one of the said reeds in the plurality of reeds in said reed switch, a variable resistor, a timing capacitor, a reset switch and a second IGFET, wherein second IGFET is also connected to coil of a relay to control a light.

2. The overhead door bolt position detection device of claim 1, wherein said low-ripple DC current is provided by an emergency energy source and a voltage regulator which provides a low voltage current source replacing said low-ripple DC current.

3. The overhead door bolt position detection device of claim 1, wherein said a third insulated gate field effect transistor (IGFET) is provided to suppress arcing of the contacts of the relay.

4. The overhead door bolt position detection device of claim 1, wherein said filter capacitor and said resistor are replaced by a discrete active component voltage regulator.

5. The overhead door bolt position detection device of claim 1, wherein said double-pole reed switch is replaced with a solid state switch.

6. The overhead door bolt position detection device of claim 1, wherein said first insulated gate field effect transistor and said second insulated gate field effect transistor are replaced with a first polysilicon gate transistor and a second polysilicon gate transistor.

7. The overhead door bolt position detection device of claim 1, wherein said variable resistor and said timing capacitor are replaced with a microcontroller.

8. The overhead door bolt position detection device of claim 1, wherein said relay is replaced with a solid state relay.

9. The overhead door bolt position detection device of claim 1, wherein active and discrete components are embedded in a module with wiring access ports.

10. The overhead door bolt position detection device of claim 1, wherein said bridge rectifier is replaced with a rectifier circuitry.

11. A method for determining the bolt position of a door latch which controls a time settable light assembly, comprising
stepping down an alternating voltage with a transformer attached to a bridge rectifier and producing a ripple laden direct voltage;
filtering said ripple laden direct voltage with a filter capacitor and a resistor to provide low-ripple DC voltage passing through a fuse for security alarm circuitry;
isolating low-ripple DC voltage by connecting to at least one contact of a reed isolating security circuitry from a lighting control circuitry;
positioning a sliding bolt fabricated from a ferromagnetic material such that when said sliding bolt is positioned between a permanent magnet and a reed switch, said sliding bolt interferes with the propagation of the magnetic field of said permanent magnet allowing the least one contact in said reed switch to assume its normal position;
connecting a first insulated gate field effect transistor (IGFET) to at least one of the said reeds in the plurality of reeds in said reed switch to a variable resistor, a timing capacitor, a reset switch and a second IGFET; and
energizing a coil of said lighting relay by the second IGFET enabling lighting control.

12. The method for determining the bolt position of a door latch which controls a time settable light assembly of claim 11 in which a battery and a voltage regulator provide a low voltage current source replacing said low-ripple DC current.

13. The method for determining the bolt position of a door latch which controls a time settable light assembly of claim 11 in which a third insulated gate field effect transistor (IGFET) is provided to suppress arcing of the contacts of the relay.

14. The method for determining the bolt position of a door latch which controls a time settable light assembly of claim 11 in which said filter capacitor and said resistor are replaced by a discrete active component voltage regulator.

15. The method for determining the bolt position of a door latch which controls a time settable light assembly of claim 11 in which said double-pole reed switch is replaced with a solid state switch.

16. The method for determining the bolt position of a door latch which controls a time settable light assembly of claim 11 in which said first insulated gate field effect transistor and said second insulated gate field effect transistor are replaced with a first polysilicon gate transistor and a second polysilicon gate transistor.

17. The method for determining the bolt position of a door latch which controls a time settable light assembly of claim 11 in which said variable resistor and said timing capacitor are replaced with a microcontroller.

18. The method for determining the bolt position of a door latch which controls a time settable light assembly of claim 11 in which said relay is replaced with a solid state relay.

19. The method for determining the bolt position of a door latch which controls a time settable light assembly of claim 11 in which active and discrete components are embedded in a module with wiring access ports.

20. The method for determining the bolt position of a door latch which controls a time settable light assembly of claim 11 in which said bridge rectifier is replaced with a rectifier circuitry.
